(19) United States
(12) Patent Application Publication
(10) Pub. No.: US 2010/0008196 A1
(43) Pub. Date: Jan. 14, 2010

(54) ABERRATION CORRECTING APPARATUS

(75) Inventors: Helmar Van Santen, Eindhoven (NL); Michael Adrianus Henricus Van Der AA, Turnhout (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,186

(22) PCT Filed: Dec. 19, 2005
(86) PCT No.: PCT/IB2005/054305

§ 371 Date: Jun. 20, 2007

(30) Foreign Application Priority Data
Dec. 27, 2004 (EP) 04106990.7

(51) Int. Cl. G11B 7/00; G02B 27/14

(52) U.S. Cl. 369/44.32; 359/637; G9B/7

(57) ABSTRACT

In optical disc systems, read-out is hampered because of spherical aberrations resulting from cover layer thickness variations or because discs consists of multiple layers. The aberration correcting apparatus (1) of the present invention is arranged to correct such an optical aberration. Therefore, the aberration correcting apparatus (1) comprises a fluid chamber containing a first fluid and a second fluid having different indices of refraction. The first (5) and second fluid (6) are in contact over a meniscus (7) acting as a refractive surface, wherein the shape of the meniscus (7) can be influenced by a magnetic field generated by a magnetizing coil (20).

### FIELD OF THE INVENTION

The present invention relates to an aberration correcting apparatus for correcting an optical aberration in an optical storage system. More particularly, the present invention relates to an aberration correcting apparatus for correcting a spherical aberration and an optical data storage device comprising such an aberration correcting apparatus for optical data storage applications using a compact disc, a digital versatile disc or a Blu-ray storage disc.

### BACKGROUND OF THE INVENTION

State of the art document US 2004/0085885 A1 describes an optical pick-up, and method and apparatus for correcting aberration caused in an optical beam radiated towards an information recording medium and focused on the medium. Thereby, an aberration corrector is provided, which is mechanically movable by a driver. The optical pick-up, and method and apparatus known from US 2004/0085885 A1 have the disadvantage that the driver is costly and error-prone.

### SUMMARY OF THE INVENTION

It is an object of the invention to provide an aberration correcting apparatus for correcting an optical aberration and an optical data storage device comprising such an aberration correcting apparatus with an increased reliability.

This object is solved by an aberration correcting apparatus as defined in claim 1 and by an optical data storage device as defined in claim 16. Advantageous developments of the invention are mentioned in the dependent claims.

The present invention has the advantage that a compact arrangement is provided, whereby the elements of the aberration correcting apparatus can be stationary mounted. Further, the liquids in the fluid chamber are influenced by the magnetic field, i.e., without a mechanical influence, so that the reliability is high.

The measure as defined in claim 2 has the advantage that both the first fluid and the second fluid are contained inside the fluid chamber so that an external liquid reservoir can be left out.

The measures as defined in claims 3 and 4 have the advantage that the radiation beam can pass directly through the fluid chamber. Thereby, the whole area from the center to the rim can be translucent for the radiation beam. Especially, the aberration correcting apparatus can be arranged at least nearly completely translucent for the radiation beam without any interfering parts, such as wires, inside the fluid chamber for interfering the way of light in another way.

The measures as defined in claims 5 and 6 have the advantage that an at least nearly symmetric shape of the meniscus can be achieved due to a current flow through the magnetizing coil to provide a spherical aberration correction.

According to the measures defined in claims 7 and 8 the magnetic force acts at least on the second fluid. Thereby, the first fluid can also be a magnetizable fluid with a different magnetic constant. The measures as defined in claims 9 and 10 have the advantage that the magnetic force acting on the second fluid is increased. Further, the measure as defined in claim 11 has the advantage that the efficiency is further increased, because the magnetic field having an effect only on the second fluid so that an appropriate shape of the meniscus can be achieved with a lower magnetic field, i.e. a lower current flow through the magnetizing coil.

The measures as defined in claims 12 and 13 have the advantage that in view of certain operations, for example, operations of the aberration correcting apparatus, the appropriate shape of the meniscus is achieved in short time and without a measurement during the operation. Thereby, it is advantageous that the control of the magnetic field generating element is based on the operational state of the optical data storage device. For example, in an optical disc system using multiple layer discs, for each of the multiple layers a value for the strength of the magnetic field generated by the magnetic field generating element can be predetermined.

These and other aspects of the invention will be apparent from and elucidated with reference to the embodiment described herein after.

### BRIEF DESCRIPTION OF THE DRAWINGS

The present invention will become readily understood from the following description of a preferred embodiment thereof made with reference to the accompanying drawings, in which like parts are designated by like reference signs and in which:

FIG. 1 shows an aberration correcting apparatus according to a preferred embodiment of the present invention;

FIG. 2 shows a graph illustrating the effect of the aberration correcting apparatus of the preferred embodiment of the present invention; and

FIG. 3 shows an optical data storage device comprising an aberration correcting apparatus as shown in FIG. 1.

### DESCRIPTION OF THE PREFERRED EMBODIMENT

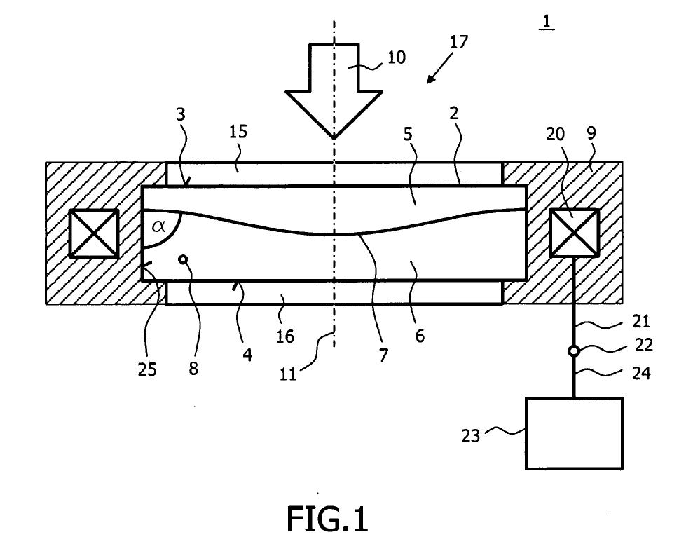

FIG. 1 shows an aberration correcting apparatus 1 according to a preferred embodiment of the invention. The aberration correcting apparatus 1 can be used in an optical storage system, especially for optical data storage using a compact disc, a digital versatile disc or a Blu-ray Disc. In such an optical storage system aberrations such as spherical aberration, coma, and astigmatism can occur. Especially, in an optical disc system read out of data is hampered because of spherical aberrations resulting from cover layer thickness variations or because discs consist of multiple layers. The aberration correcting apparatus of the invention provides a tunable aberration correction that can correct these aberrations. It is to be noted that the aberration correcting apparatus 1 of the invention is not limited to this mentioned data storage systems and can also be used in other applications.

The aberration correcting apparatus 1, as shown in FIG. 1, comprises a fluid chamber 2. The fluid chamber 2 comprises a first transparent sidewall 3 and a second transparent sidewall 4 which is opposed to the first transparent sidewall 3. The fluid chamber 2 contains a first fluid 5 and a second fluid 6. The first fluid 5 and the second fluid 6 are immiscible and are in contact over a meniscus 7. The first fluid 5 is a non-magnetic fluid. The second fluid 6 comprises encapsulated magnetic particles in a carrier fluid, whereby it is preferred that the magnetic particles are very small, and only for the way of illustration an exemplary magnetic particle 8 is shown in FIG. 1. It is advantageous that the magnetic particle 8 is a ferromagnetic particle 8 so that the second fluid 6 is a ferromagnetic fluid 6.

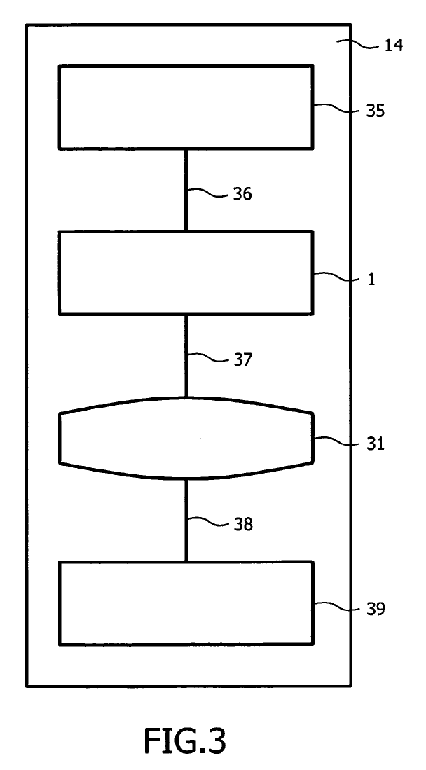

The aberration correcting apparatus 1 comprises a casing 9, in which the fluid chamber 2 is arranged. The casing 9 is arranged so that a radiation beam incidenting in a direction 10 parallel to an axis 11 of the casing 9 of the aberration correcting apparatus 1 passes through the fluid chamber 2, wherein the radiation beam first passes through the first transparent sidewall 3, then through the first fluid 5 and second fluid 6 and then through the second transparent sidewall 4. A recess 15 and a recess 16 of the casing 9 are provided to let the radiation beam pass through the casing 9. Recess 15 and 16 might have additional functionality, e.g. their surfaces could be structured to include an optical active element such as a grating, a quarter/half wave plate, a focusing lens 31, as shown in FIG. 3, etc.

The aberration correcting apparatus 1 comprises a magnetizing coil 20, which is arranged inside the casing 9 and surrounds the fluid chamber 2. The magnetizing coil 20 is connected over a line 21 with a connecting point 22. The connecting point serves to connect a control unit 23 of the aberration correcting apparatus 1 over a line 24 with the magnetizing coil 20. The control unit 23 controls, for example, the current flowing through the magnetizing coil 20. The magnetizing coil 20 forms a magnetic field generating element 20, wherein the strength of the magnetic field generated by the magnetizing coil 20 in a region 17 of said fluid chamber 2 is controlled by the control unit 23. Thereby, the control unit 23 controls the current flowing through the magnetizing coil 20. The course of the magnetic lines of force is influenced by the specific arrangement of the magnetic field generating element 20. Thereby it is possible, to arrange two or more magnetizing coils 20 or an additional permanent magnet.

When current flows through the magnetizing coil 20, the second fluid 6, which is a ferrofluid, is drawn to the magnetizing coil 20 and the meniscus 7 is shaped, as shown in FIG. 1. When the current vanishes, the meniscus 7 forms an at least nearly flat contact surface between the first fluid 5 and the second fluid 6, which contact surface is orientated at least nearly perpendicular to the axis 11. Hence, a spherical aberration can be added to the beam in combination with some defocus by the aberration correcting apparatus 1. The amount of the spherical aberration can be switched between certain values by applying current flows of predetermined values.

The second fluid 6 consists of nanoparticles of encapsulated ferromagnetic particles in a carrier fluid and a dispersant. The second fluid 6 may be water based or oil based. In case of a water based second fluid 6, the first fluid 5 can be for instance a silicon oil or an alkene. In case of an oil based second fluid 6, the first fluid 5 can be for instance a water or ethylene glycol.

By selecting the first fluid 5, the second fluid 6 and the material of the sidewall 25 of the fluid chamber 2, a contact angle α between the meniscus 7 and the sidewall 25 can be selected. A contact angle α of 90° is preferable to give no defocus when there is no current flow through the magnetizing coil 20. With an higher contact energy at the sidewall 25, the interface at the sidewall 25 can be pinned, thereby reducing the amount of defocus that is added and decreasing the effect of density variations.

It is preferred that the first transparent sidewall 3 and the second transparent sidewall 4 have a low contact energy with the first fluid 5 and/or the second fluid 6.

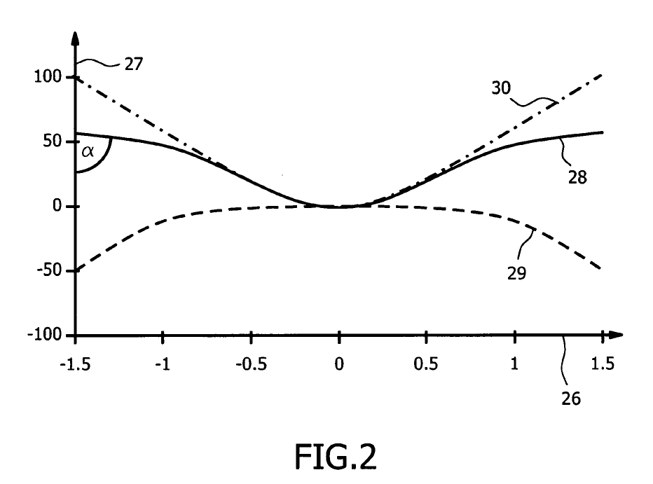

FIG. 2 shows a diagram to illustrate the effect of the aberration correcting apparatus I of the preferred embodiment of the invention. On the axis 26 of abscissas a radial distance from the axis 11 is shown. This distance can be measured, for example, in units of 1 mm. On the axis 27 of ordinates a distance of shift from the initial position (no current flow) is shown. This distance can be measured, for example, in units of 1 μm. The solid line 28 shows the shape of the meniscus 7, when a current is applied to the magnetizing coil 20. This current is greater than the current applied to form the meniscus 7 shown in FIG. 1 so that the contact angle a is less than 90°. The discontinuous line 29 shows the spherical aberration added to a radiation beam passing in the direction 10 through the fluid chamber 2. The first fluid 5 and the second fluid 6 have different indices of refraction. Hence, the meniscus 7 shown by the line 28 acts as a refractive surface. Hence, an aberration of the radiation beam can be corrected by the aberration correcting apparatus 1.

A dot-dash line 30 shows a defocus also added to the radiation beam. If necessary, this defocus can be corrected by a further optical element, for example a suitable focusing lens 31, as shown in FIG. 3.

FIG. 3 shows an optical data storage device 14 according to the preferred embodiment of the invention.

The optical data storage device 14 comprises an optical pick-up device 35 for read-out of data stored on a compact disc, a digital versatile disc, a Blu-ray Disc or another optical storage medium. The optical pick-up device 35 outputs a radiation beam 36 to the aberration correcting apparatus 1. An aberration of the radiation beam 36 input to the aberration correcting apparatus 1 is corrected in the aberration correcting apparatus 1 and an aberration corrected radiation beam 37 is output. As described above, a certain amount of defocus is added in the aberration correcting apparatus 1 to the radiation beam 37. This amount of defocus is corrected with the focusing lens 31. The aberration corrected and focused radiation beam 38 is input to a decoding unit 39 for converting the information encoded in the radiation beam 38 to digital data.

The invention can be summarised as follows. In optical disc systems, read-out is hampered because of spherical aberrations resulting from cover layer thickness variations or because discs consists of multiple layers. The aberration correcting apparatus 1 of the present invention is arranged to correct such an optical aberration. Therefore, the aberration correcting apparatus 1 comprises a fluid chamber containing a first fluid and a second fluid having different indices of refraction. The first 5 and second fluid 6 are in contact over a meniscus 7 acting as a refractive surface, wherein the shape of the meniscus 7 can be influenced by a magnetic field generated by a magnetizing coil 20.

Although an exemplary embodiment of the invention has been disclosed, it will be apparent to those skilled in the art that various changes and modifications can be made which will achieve some of the advantages of the invention without departing from the spirit and scope of the invention, such modifications to the inventive concept are intended to be covered by the appended claims in which the reference signs shall not be construed as limiting the scope of the invention. Further, in the description and the appended claims the meaning of “comprising” is not to be understood as excluding other elements or steps. Further, “a” or “an” does not exclude a plurality, and a single processor or other unit may fulfill the functions of several means recited in the claims. Also, the wavelength of the radiation beams is not limited to the visible spectrum.

1. Aberration correcting apparatus (1) for correcting an optical aberration in an optical storage system, which aberration correcting apparatus comprises:
a fluid chamber (2) comprising an at least partially transparent sidewall (3) to enable irradiation of a radiation beam in said fluid chamber (2), a magnetic field generating element (20) for generating a magnetic field at least in a region (17) of said fluid chamber (2), a first fluid (5) and at least a second fluid (6) having different indices of refraction,
wherein said fluid chamber contains said first fluid and said second fluid,
wherein said first fluid and said second fluid are at least substantially immiscible and are in contact over a meniscus (7) acting as a refracting surface for said radiation beam, and
wherein said second fluid is at least partially movable by influence of said magnetic field generated by said magnetic field generating element to affect a shape of said meniscus.

2. Aberration correcting apparatus according to claim 1, characterized in that said second fluid is at least at most moveable inside said fluid chamber with respect to said first fluid by influence of said magnetic field generated by said magnetic field generating element (20).

3. Aberration correcting apparatus according to claim 1, characterized in that said fluid chamber (2) comprises a further transparent sidewall (4) opposing said transparent sidewall (3), and that said radiation beam enters said fluid chamber through said transparent sidewall, passes through said first fluid, said second fluid and the meniscus formed between said first fluid and said second fluid, and emanates from said fluid chamber through said further transparent sidewall.

4. Aberration correcting apparatus according to claim 3, characterized in that said aberration correcting apparatus is arranged in that in case that said radiation beam enters said fluid chamber (2) at least nearly in a direction (10) parallel to an axis (11) of said fluid chamber, said radiation beam also emanates from said fluid chamber at least nearly in said direction parallel to said axis of said fluid chamber.

5. Aberration correcting apparatus according to claim 1 characterized in that said magnetic field generating element (20) comprises at least a magnetizing coil (20).

6. Aberration correcting apparatus according to claim 5, characterized in that said magnetizing coil (20) surround said fluid chamber (2).

7. Aberration correcting apparatus according to claim 1, characterized in that said second fluid (4) is a magnetizable fluid.

8. Aberration correcting apparatus according to claim 7, characterized in that said second fluid (4) comprises encapsulated magnetizable particles in a carrier fluid.

9. Aberration correcting apparatus according to claim 1, characterized in that said second fluid (6) is a magnetic fluid.

10. Aberration correcting apparatus according to claim 9, characterized in that said second fluid (4) comprises encapsulated magnetic particles in a carrier fluid.

11. Aberration correcting apparatus according to claim 1, characterized in that said first fluid (5) is a non-magnetic fluid.

12. Aberration correcting apparatus according to claim 1, characterized by a control unit (23) connected with said magnetic field generating element (20) for controlling the strength of said magnetic field generated by said magnetic field generating element, wherein said control unit is arranged to control said magnetic field generating element in a way that said strength of said magnetic field is switched between at least two different predetermined values.

13. Aberration correcting apparatus according to claim 1, characterized in that said magnetic field at least nearly vanishes for one of said different predetermined values.

14. Aberration correcting apparatus according to claim 1, characterized by a focusing lens (31) for correcting a defocus of said radiation beam.

15. Aberration correcting apparatus according to claim 1, characterized by a casing (9), wherein said fluid chamber is arranged inside said casing, and said casing comprises at least a recess (15, 16) which recess is adapted for mounting an optical active element such as a grating, a quarter/half wave plate, or a focusing lens (31).

16. Optical data storage device for optical data storage comprising an aberration correcting apparatus according to 1.
